(19) United States
(12) Patent Application Publication
(10) Pub. No.: US 2008/0087336 A1
(43) Pub. Date: Apr. 17, 2008

(54) FLUID-PROCESSING APPARATUS AND FLUID-PROCESSING SYSTEM

(75) Inventors: Susumu Yasuda, Tsukuba-shi (JP); Mamoru Tsukada, Fujisawa-shi (JP); Takahiro Ezaki, Yokohama-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 11/869,415

(22) Filed: Oct. 9, 2007

(30) Foreign Application Priority Data
Oct. 11, 2006 (JP) 2006-278110(PAT.)

(51) Int. Cl. F16L 9/00

(52) U.S. Cl. 137/561 R

(57) ABSTRACT

The present invention provides a fluid-processing apparatus which can uniformly mix or react fluids with each other by discharging the fluids from many nozzles at a uniform discharge pressure to collide them. A fluid-processing apparatus that has a first unit provided with one inlet for supplying a fluid therethrough, N pieces of transportation paths which are branched into N pieces from one path leading to one inlet, and N pieces of outlets connecting to the N pieces of transportation paths, and a second unit provided with one inlet, N pieces of transportation paths, and N pieces of outlets so as to correspond to the first unit, includes bringing a first fluid which flows out from the outlet of the first unit into contact with a second fluid which flows out from the outlet of the second unit to mix and react the fluids with each other, wherein variations among lengths of the N pieces of the transportation paths in the first unit and lengths of the N pieces of transportation paths in the second unit are controlled into 20% or less.

### BACKGROUND OF THE INVENTION

1. Field of the Invention

The present invention relates to a fluid-processing apparatus and fluid-processing system for mixing and reacting fluids with each other, and is suitable for a fluid-processing apparatus and a fluid-processing system particularly for producing a solid matter when mixing the fluids.

2. Description of the Related Art

In recent years, in the chemical industry relating to the manufacture of pigment and the like to be used in an inkjet printer, and in the pharmaceutical industry relating to the manufacture of a medicinal drug and a chemical reagent, a new manufacturing process has been developed which uses a micro container referred to as a micro-mixer or a micro-reactor. A conventional batch-type reactor has a risk of causing the non-uniformity of a product, because the primary product sequentially reacts in the reactor. Particularly, when the conventional batch-type reactor produces particles, primary particles of once produced particles may further continue the reaction and growth to cause the non-uniformity in sizes of the particles. In contrast to this, the micro-mixer can prevent the once produced particles from reacting again and enhance the uniformity of the sizes of the particles, because the fluids continuously pass through a flow path of a microscale without staying therein. By the way, the micro-mixer and the micro-reactor are considered to have basically a common structure, but the term micro-reactor is occasionally used particularly when a plurality of solutions cause a chemical reaction while being mixed. For this reason, the term micro-mixer shall include the micro-reactor in the following description.

As for such a micro-mixer, a method is disclosed which forms a solid precipitation by mixing two liquids at a high speed as is illustrated in FIG. 13 (Japanese Patent Application Laid-Open No. 2002-336667). This is a method of forming the solid precipitation in a jet collision mixing chamber 1104, by supplying two liquids to orifices 1101 and 1102 and subsequently passing them through a divergent shield part 1103 at a high speed.

In addition, a micro-mixer which has an inclined nozzle formed by machining as illustrated in FIG. 13 and is made from a metal is commercially available (impinging Jet Micro Mixer, made by Institut fur Mikrotechnik Mainz Corporation). This is a micro-mixer which spouts the liquids from the nozzles 1201 and 1202 and mixes the spouted liquids in the air. It is possible to produce finer particles with a narrower particle size distribution by using the micro-mixer with such characteristics as described above than using a conventional batch method which employs a tank with a large capacity as a space for mixing and reacting the liquids with each other.

In order to further reduce the size of particles and uniformize particle diameters by improving the mixture efficiency of the above described technology, it is necessary to reduce a diameter of a nozzle and an absolute amount of a liquid. In addition, in order to enhance the productivity, it is necessary to prepare many nozzles. However, when many nozzles are provided, the micro-mixer may hinder the particle diameters from being uniformized, because each nozzle spouts the liquid in a different pressure.

Furthermore, when a plurality of nozzles are provided in a processing apparatus which collides two fluids discharged from each nozzle, and mixes and reacts them with each other, in order to enhance the productivity, each of the nozzles may hinder a reaction from being uniformized, because of discharging the liquid in a different pressure.

### SUMMARY OF THE INVENTION

The present invention is directed to a fluid-processing apparatus comprising first and second units each of which units is comprised of one inlet in which a fluid flows, a set of transportation paths divaricated in turn from the inlet as an origin and outlets at the ends of the transportation path, and bring a first fluid flowing from the outlet of the first unit into contact with a second fluid flowing from the outlet of the second unit to mix the fluids or bring the fluids react with each other, transportation paths from the inlet to the outlets varying in length in a range of 20% or less.

The set of transportation paths can be firstly bifurcated from the inlet to form two first branching paths, and further bifurcated from each of the first branching paths to form two second branching paths. The first branching paths and the second branching paths can be formed in their respective substrates different from each other. The different substrates can be stacked on each other to connect the first branching paths with the second branching paths.

The number of the outlets and the ends of the set of transportation paths can be an integral multiple of 2.

The inlet can be prepared on a center line of the set of transportation paths.

The present invention is directed to a fluid-processing system comprising the fluid-processing apparatus, a transportation unit for transporting a fluid, a fluid control unit for controlling the transportation unit, a feed material-storing unit for storing the fluid to be supplied to the fluid-processing apparatus, and an outflow-storing unit for storing the fluid which has flowed out from the fluid-processing apparatus.

The present invention is directed to a fluid-processing apparatus comprising first and second units each of which units is comprised of one inlet in which a fluid flows, a set of transportation paths divaricated in turn from the inlet as an origin and outlets at the ends of the transportation path, and bring a first fluid flowing from the outlet of the first unit into contact with a second fluid flowing from the outlet of the second unit to mix the fluids or bring the fluids react with each other, the set of transportation paths comprising branching paths with greater cross sectional areas as away from the inlet.

The set of transportation paths can comprise a main flow path which connects to the inlet and compensation paths branching from the main flow path, the compensation paths being different from each other in cross sectional area. The compensation paths can be equal in length.

The present invention is directed to a fluid-processing system comprising the fluid-processing apparatus, a transportation unit for transporting a fluid, a fluid control unit for controlling the transportation unit, a feed material-storing unit for storing the fluid to be supplied to the fluid-processing apparatus, and an outflow-storing unit for storing the fluid which has flowed out from the fluid-processing apparatus.

The present invention is to provide a fluid-processing apparatus for uniformly mixing or reacting fluids with each other by making the fluids discharged from nozzles in uniform pressures respectively, in a fluid-processing apparatus for mixing or reacting fluids by making the fluids discharged from many nozzles to collide the fluids.

In addition, the present invention can provide a fluid-processing system using the fluid-processing apparatus which uniformly mixes or reacts the fluids with each other.

Further features of the present invention will become apparent from the following description of exemplary embodiments with reference to the attached drawings.

### BRIEF DESCRIPTION OF THE DRAWINGS

FIG. 1 is a perspective view illustrating a fluid-processing apparatus according to Example 1 of the present invention.

FIGS. 2A, 2B and 2C are explanatory views for describing a fluid-processing apparatus according to Example 1 of the present invention.

FIGS. 3A, 3B and 3C are explanatory views for describing one example of a fluid-processing apparatus according to the present invention.

FIGS. 4A, 4B, 4C, 4D and 4E are explanatory views for describing a fluid-processing apparatus according to Example 2 of the present invention.

FIGS. 5A, 5B, 5C and 5D are explanatory views for describing a fluid-processing apparatus according to Example 3 of the present invention.

FIG. 6 is an explanatory view for describing a fluid-processing apparatus according to Example 4 of the present invention.

FIG. 7 is an explanatory view for describing a fluid-processing apparatus according to Example 5 of the present invention.

FIG. 8 is a schematic view for describing an effect of a branching path of a fluid-processing apparatus according to the present invention.

FIG. 9 is an equivalent circuit view for describing an effect of a branching path of a fluid-processing apparatus according to the present invention.

FIG. 10 is a schematic view for describing an effect of a compensation path of a fluid-processing apparatus according to the present invention.

FIG. 11 is an equivalent circuit view for describing an effect of a compensation path of a fluid-processing apparatus according to the present invention.

FIG. 12 is an explanatory view for describing a fluid-processing system according to the present invention.

FIG. 13 is an explanatory view for describing a conventional fluid-processing apparatus.

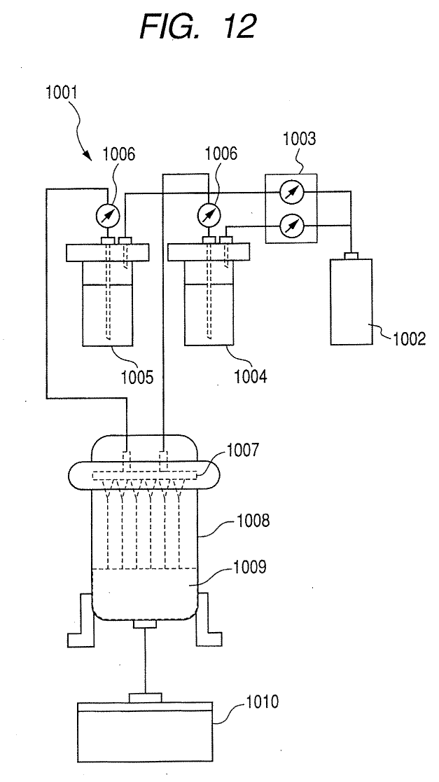

FIG. 14 is an explanatory view for describing a conventional fluid-processing apparatus.

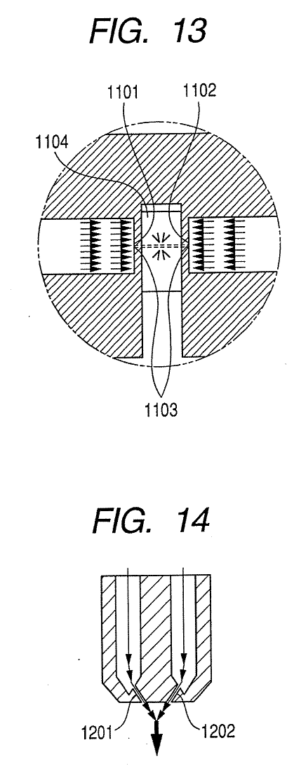

### DESCRIPTION OF THE EMBODIMENTS

The present invention will be described in detail below. Preference symbols for description are defined below including those not specified the drawings.
Nozzles: 101a to 116a, 101b to 116b, 201a and 201b to 208a and 208b, 301a and 301b to 308a and 308b, and 601 and 801,
TUBE CONNECTORS: 129A, 129B, 229A, 229B, 329A and 329B, branching paths: 220a, 220b, 420a, 420b, 430a, 430b 440a, 440b, 520a, 520b, 530a and 530b, inlets: 221a, 221b, 410a, 410b, 510a, 510b, 621 and 821,
compensation paths: 311a to 318a, 311b to 318b, 451a to 458a, and 451b to 458b,
branching path substrates: 131 to 134, 231, 400 and 500,
nozzle substrates: 135, 232 and 333,
main flow path substrate: 331,
compensation path substrate: 332,
flow paths: 421a, 422a, 431a, 431b, 432a, 432b, 521a, and 521b to 523a and 523b, 531a and 531b to 533a and 533b,
nozzle connection ports: 460a, 460b, 540a and 540b,
inlet: 621,
branching paths: 622 to 624,
nozzle equivalent elements: 701 and 901,
equivalent resistances of branching paths: 722 to 724
voltage sources: 730 and 930,
compensation paths: 810(1) to 810(n),
main flow path: 820,
flow resistances of compensation paths: 910(1) to 910(n),
equivalent resistance of main flow path: 920,
fluid-processing system: 1001,
high pressure gas: 1002,
regulator: 1003,
first reaction tank: 1004,
second reaction tank: 1005,
flow meter: 1006,
fluid-processing apparatus: 1007,
reaction vessel: 1008,
recovery tank: 1010,
orifices: 1101 and 1102,
divergent shield part: 1103,
jet collision mixing chamber: 1104, and
nozzles: 1201 and 1202.

A fluid-processing apparatus according to the present invention has first and second units, wherein each of the first and second units has a plurality of fluid outlets, a plurality of fluid inlets, and transportation paths connecting the plurality of the inlets with the plurality of the outlets.

The first embodiment is characterized in that variations among lengths of a plurality of the transportation paths between the inlet and the plurality of outlets in the first and second units are regulated into 20% or less, and that the lengths are substantially the same. The second embodiment is characterized in that the cross-sectional areas of the plurality of the transportation paths between the inlet and the plurality of the outlets in the first and second units are each different from others. The structures shown in the above described two embodiments equalize pressure drops between the inlet and the plurality of the outlets as well as flow resistances of the transportation paths, uniformize a discharging pressure of each nozzle, and thereby uniformly mix or react fluids with each other.

Furthermore, the above described first and second units have a plurality of spouting nozzles at a plurality of the outlets, wherein the plurality of the spouting nozzles are arranged so that the spouting directions intersect in the space.

A fluid-processing apparatus according to a first embodiment of the present invention will be now described, in which a plurality of transportation paths between the above described inlets and a plurality of the above described outlets in first and second units have substantially the same length respectively.

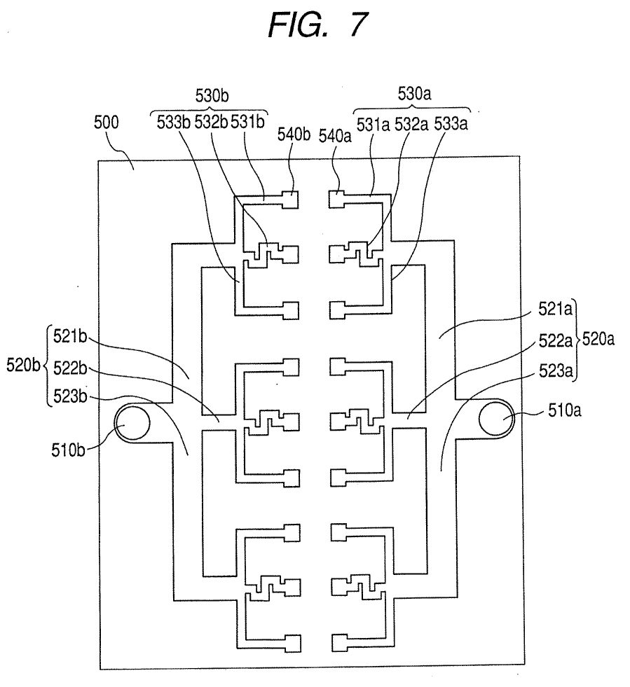

An effect of a branching path according to the present invention will be now described in detail. FIG. 8 is a schematic view for describing an effect of the branching path of the fluid-processing apparatus according to the present invention. As illustrated in the drawing, the branching path 622 is connected to the inlet 621. The branching path 622 branches into two paths, and the outlet of the branching path 622 is connected to the inlet of the branching path 623. The branching path 623 branches into two paths and the outlet of the branching path 623 is connected to the inlet of the branching path 624. In addition, the outlet of the branching path 624 is connected to a nozzle (outlet) 601. A fluid flowing from the inlet 621 passes through the branching path 622 and the branching path 624, and spouts from the nozzle (outlet) 601.

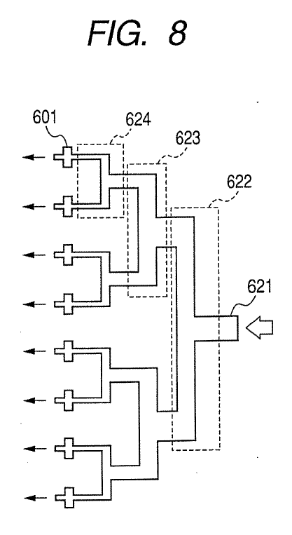

Such an equivalent circuit as in FIG. 9 is considered with regard to the paths illustrated in FIG. 8. In the equivalent circuit of the FIG. 97 pressure corresponds to voltage, a flow rate to an electric current, and flow resistance to electrical resistance. Reference numeral 701 denotes a nozzle equivalent element, reference numerals 722 to 724 denote the equivalent circuit of branching paths, and reference numeral 730 denotes a voltage source.

When an inlet flow velocity is represented by (Vᵢₙ), an inlet cross-sectional area by (Aᵢₙ), an outlet flow velocity by (Vₒᵤₜ), an outlet cross-sectional area by (Aₒᵤₜ) in the nozzle equivalent element 701, a relationship of a flow rate (q) with the above factors is expressed by Expression 1 described below.
q=Aᵢₙvᵢₙ=Aₒᵤₜvₒᵤₜ (Expression 1)
On the other hand, when an inlet pressure is represented by (P) and an outlet pressure by (O), and assuming that the Bernoulli's theorem holds in the nozzle equivalent element 701, a relationship among the above factors is expressed by Expression 2 described below.

$$\frac{1}{2} {v}_{i n}^{2} + \frac{P}{ρ} = \frac{1}{2} {v}_{out}^{2} \qquad ( Expression 2 )$$

According to Expressions 1 and 2, the flow rate (q) is expressed by the Expression 3 described below.

$$q = \sqrt{\frac{2 P}{ρ ( 1 / {A}_{out}^{2} - 1 / {A}_{i n}^{2} )}} \qquad ( Expression 3 )$$

The flow rate (q) is proportionate to a square root of the inlet pressure (P). Here, ρ represents the density of the fluid.

A flow resistance (r) is a ratio of a pressure difference (p) to the flow rate (q), and when the flow is a laminar flow, and assuming that a viscosity coefficient of a fluid is represented by μ, a diameter of a circular tube by (D) and a length by (L), a flow resistance r_{circle} of the circular tube is expressed by Expression 4 described below.

$${r}_{circle} = \frac{128 μ L}{π {D}^{4}} \qquad ( Expression 4 )$$

In addition, when a cross-sectional shape is a rectangle having each side length of (a) and (b), the flow resistance r_{rect} is approximated by the Expression described below.

$${r}_{rect} = \frac{32 μ L}{{a}^{2} {b}^{2}} \qquad ( Expression 5 )$$

In the equivalent circuit of FIG. 9, all the voltages applied to eight nozzle equivalent elements 701 are equal on the basis of Kirchhoff's law. In other words, it is understood that fluid pressures applied to a plurality of nozzles are approximately equal in the fluid-processing apparatus according to the present invention.

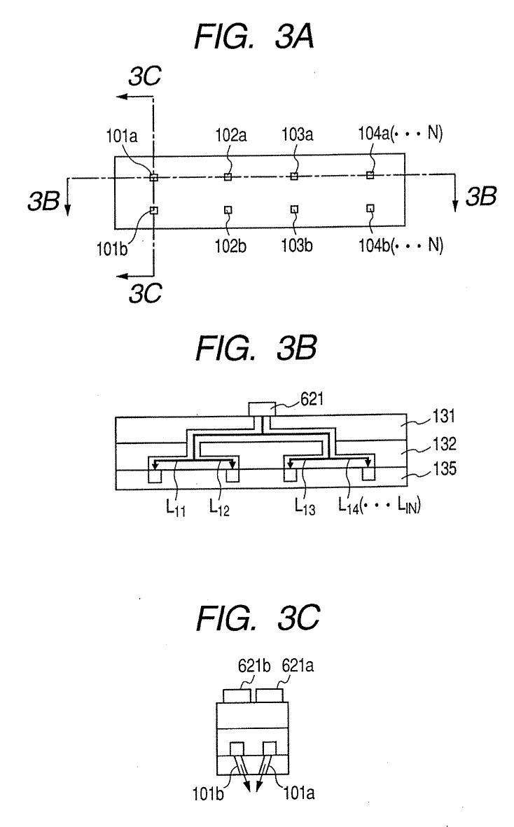

In the next place, a fluid-transportation apparatus according to a first aspect of the present invention will be described with reference to FIGS. 3A and 3B.

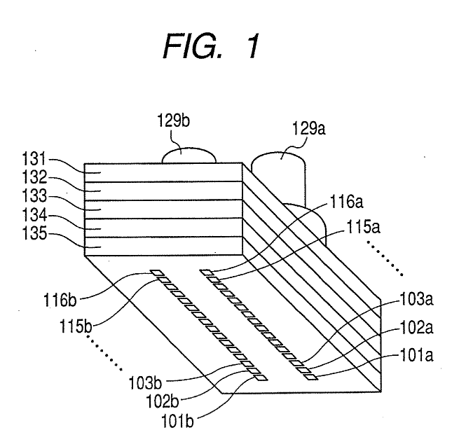

The apparatus illustrated in FIGS. 3A and 3B are similar to that illustrated in FIG. 1 (perspective view) described later, and FIG. 3A illustrates the apparatus similar to that in FIG. 1, when viewed from a lower part. FIG. 3B is a cross-sectional view cut along a line 3B-3B in FIG. 3A, and FIG. 3C is a cross-sectional view cut along a line 3C-3C in FIG. 3A.

In FIG. 3A, outlets 101a, 102a, 103a, 104a (continuing to N) make a fluid introduced from an inlet 621 flow out, and the inlet 621 is connected to the respective outlets through four branching transportation paths as illustrated in FIG. 3B. Lengths of the four transportation paths are represented by L₁₁, L₁₂, L₁₃ and L₁₄ respectively, and in the apparatus according to the present aspect, variations among the lengths are regulated to 20% or less, in other words, the apparatus is designed so that the lengths are substantially equal.

A first unit has the inlet 621a, the four transportation paths, and the four outlets (101a, 102a, 103a and 104a) illustrated in FIGS. 3A, 3B and 3C.

In addition, a second unit has an inlet 621b, four transportation paths, and four outlets (101b, 102b, 103b, and 104b) in correspondence with the first unit.

The four transportation paths in the second unit are arranged separately from the first unit, and the variation among respective lengths L₂₁, L₂₂, L₂₃ and L₂₄ is regulated to 20% or less. Consequently, the variation among L₁₁, L₁₂, L₁₃, L₁₄, L₂₁, L₂₂, L₂₃ and L₂₄ is regulated to 20% or less. The transportation apparatus according to the present aspect introduces a first fluid from the inlet 621a, transports the first fluid through the four transportation paths, and makes the first fluid flow out through the four outlets (101a, 102a, 103a and 104a). The transportation apparatus similarly introduces a second fluid from an inlet 621b, transports the second fluid through the four transportation paths, and makes the second fluid flow out through four outlets (101b, 102b, 103b and 104b). The first fluid and the second fluid flow out from a pair of the outlets (for instance, 101a and 101b), then contact each other, and are mixed or react with each other.

In FIG. 3B, a nozzle (outlet) substrate 135 and flow path substrates 131 and 132 having branching paths formed therein respectively are stacked to compose a processing apparatus. A fluid-processing apparatus illustrated in FIGS. 3A to 3C has four transportation paths as N pieces of the transportation paths, but it is practical to set the number of the transportation paths at an integral multiple of 2. In addition, an inlet can be placed in the central part of the N pieces of the transportation paths.

In the next place, a apparatus according to a second embodiment of the present invention will be described.

Specifically, the fluid-processing apparatus to be described now has such a plurality of transportation paths as respective cross-sectional areas are different from others, in between an inlet and a plurality of outlets in first and second units.

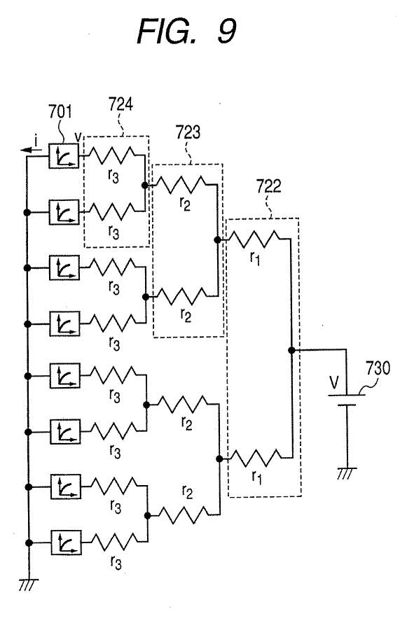

An effect of a compensation path according to the present invention will be now described in detail. FIG. 10 is a schematic view for describing an effect of a compensation path of a fluid-processing apparatus according to the present invention. A main flow path 820 is connected to an inlet 821 and n lines of compensation paths 810(1) to 810(n), as is illustrated in the figure. Nozzles 801 of outlets are connected to the other ends of the compensation paths 810(1) to 810(n). The fluid flows into the main flow path 820 through the inlet 821, passes through the main flow path 820 and the compensation paths 810(1) to 810(n), and spouts from the nozzles 801.

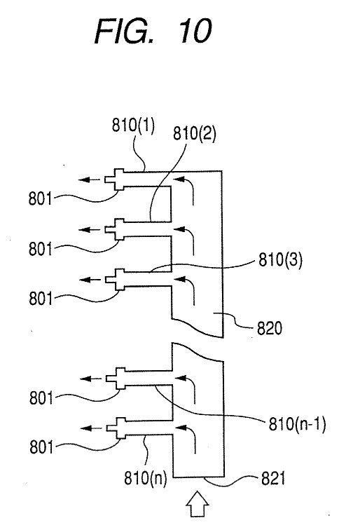

Such an equivalent circuit as in FIG. 11 is considered with regard to the paths. In the equivalent circuit, pressure corresponds to voltage, a flow rate to an electric current, and flow resistance to electrical resistance. Reference numeral 901 denotes a nozzle equivalent element, reference numerals 910(1) to 910(n) denote the flow resistances of a compensate path, reference numeral 920 denotes equivalent resistance that corresponds to one of n equal parts divided from the flow resistance of the main flow path, and reference numeral 930 denotes a voltage source. The nozzle equivalent element 901 has the same characteristics as a nozzle equivalent element 701. Assume that resistance values of the flow resistances 910 (1) to 910 (n) are represented by r1 to rn respectively, the resistance value of the flow resistance 920 by (R), and a pressure of the pressure source 930 by (P).

In order to make the pressures (p) and flow rates (q) in the nozzle equivalent elements 901 all equal, a relationship expressed by the following Expression 6 and Expression 7 needs to hold.

$$p = P - ( {r}_{j} + R {\sum }_{k = i}^{n} k ) q \\ {r}_{i} = \frac{P - p}{q} - R {\sum }_{k = i}^{n} k \qquad ( Expression 6 )$$

(Expression 7)

Because all the values rᵢ in Expression 7 must be positive, a relationship expressed by the following Expression 8 holds.

$$\frac{P - p}{q} > R {\sum }_{k = 1}^{n} k \qquad ( Expression 8 )$$

The fluid-processing apparatus according to the present invention makes fluid pressures applied to a plurality of nozzles approximately equal, and accordingly can more uniformly mix the fluids.

### EXAMPLES

In the next place, the present invention will be more specifically described with reference to Examples.

### Example 1

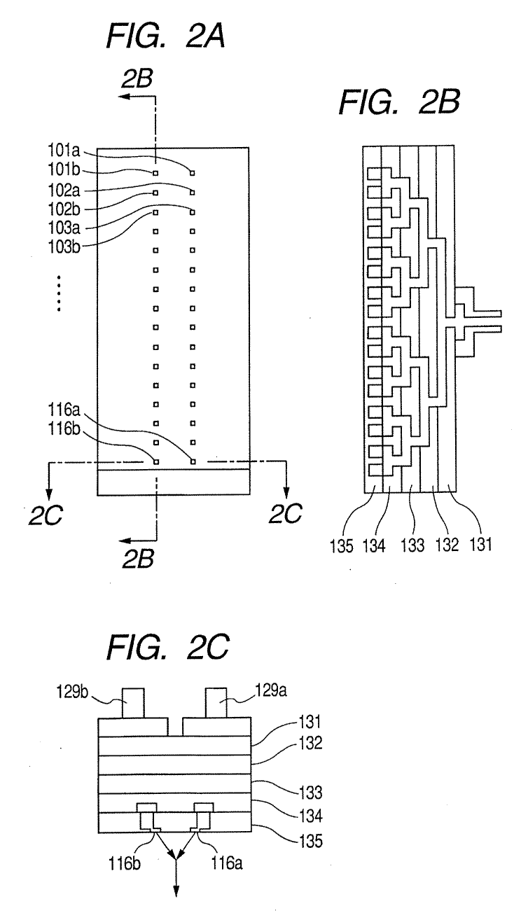

A fluid-processing apparatus according to the present invention will be now described with reference to the drawings. FIG. 1 is a perspective view illustrating a fluid-processing apparatus according to Example 1 of the present invention. In addition, FIG. 2A is a view illustrating the fluid-processing apparatus according to the present Example 1 when viewed from a lower side, FIG. 2B is a cross-sectional view cut along a line 2B-2B in FIG. 2A, and FIG. 2C is a cross-sectional view cut along a line 2C-2C in FIG. 2A. An integrated micro-mixer according to the present example is produced by stacking branching path substrates 131 to 134 on a nozzle substrate 135. Reference numerals 101a to 116a and 101b to 116b denote nozzles formed on the nozzle substrate 135, and reference numerals 129a and 129b denote tube connectors.

The branching path substrates 131 to 134 and the nozzle substrate 135 are formed by perpendicularly etching a silicon substrate from both sides. The nozzles 101a to 116a and 101b to 116b formed on the nozzle substrate 135 are formed by connecting holes etched from one side to holes etched from the other side, and are formed so that the gravity centers of the holes are deviated from each other. Because of being thus formed, each nozzle spouts a fluid not in a perpendicular direction to a substrate but at an arbitrary angle with respect to the substrate. In addition, the nozzles 101a to 116a and 101b to 116b are arranged so that respective spouting directions intersect with each other, and form mixing units respectively. Tube connectors 129a and 129b are produced by machining stainless steel, and are bonded to a branch path substrate 131 with an adhesive.

In the next place, an operation of the fluid-processing apparatus according to the present example will be described. When a fluid is introduced into a branching path formed in a branching path substrate 131 through a tube connector 129a with a pump, the fluid branches into two therein.

Then, fluids branched into two are further branched into two respectively in branching paths formed in a branching path substrate 132. Subsequently, the fluids branch into 16 when reaching a branching path substrate 134, in a similar way. Then, the branched fluids spout from nozzles 101a to 116a formed in a nozzle substrate 135. Because pressure drops between inlets and outlets are equal in each of the branching paths, an approximately equal pressure is applied to the nozzles 101a to 116a. A fluid having flowed into a branching path through a tube connector 129b spouts from 101b to 116b in the same manner. Then, the spouted fluids collide with each other, and are mixed or cause a reaction in the collision part, because the nozzles 101a to 116a and the nozzles 101b to 116b are arranged so that each spouting direction intersects with each other.

The fluid-processing apparatus according to the present example has the same length of transportation paths, accordingly approximately equalize respective pressures applied to nozzles, makes mixing conditions or reaction conditions uniform, and can adequately mix the fluids or cause a reaction between them.

### Example 2

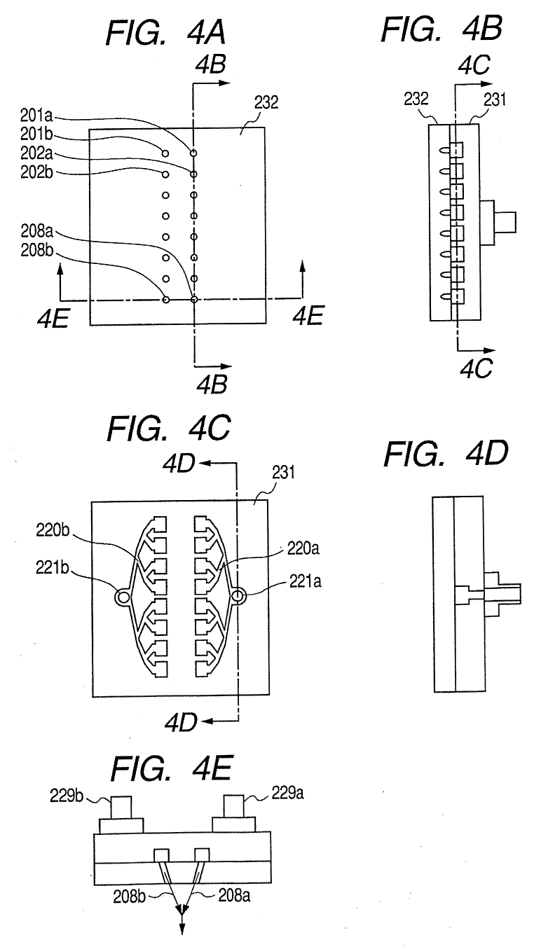

FIGS. 4A and 4B are explanatory views for describing a fluid-processing apparatus according to Example 2 of the present invention. FIG. 4A is a view illustrating the fluid-processing apparatus according to Example 2 when viewed from a lower side, and FIG. 4B is a cross-sectional view cut along a line 4B-4B in FIG. 4A. In addition, FIG. 4C is a cross-sectional view cut along a line 4C-4C in FIG. 4B, FIG. 4D is a cross-sectional view cut along a line 4D-4D in FIG. 4C, and FIG. 4E is a cross-sectional view cut along a line 4E-4E in FIG. 4A. An integrated micro-mixer according to the present example is produced by stacking a branching path substrate 231 on a nozzle substrate 232. Reference numerals 201a to 208a and 201b to 208b denote nozzles, and reference numerals 229a and 229b denote tube connectors.

The branching path substrate 231 has branching flow paths 220a and 220b, and inlets 221a and 221b formed by etching a silicon substrate in a perpendicular direction from both sides. The nozzle substrate 232 is made of a glass plate, and has the nozzles 201a to 208a and 201b to 208b formed therein by opening inclined holes with a laser beam, as illustrated in FIG. 4E. Because of being thus formed, each nozzle spouts a fluid not in a perpendicular direction to the substrate but at an arbitrary angle with respect to the substrate.

In addition, the nozzles 201a to 208a and 201b to 208b are arranged so that respective spouting directions intersect with each other, and form mixing units respectively.

Tube connectors 229a and 229b are produced by machining stainless steel, and are bonded to the branch path substrate 231 with an adhesive.

In the next place, an operation of the fluid-processing apparatus according to the present example will be described. When a fluid is sent into an inlet 221a from a tube connector 229a with a pump, the sent fluid branches into eight paths at a branching path 220 formed in a branching path substrate 231. Then, the branched fluids spout from nozzles 201a to 208a formed in a nozzle substrate 232. At this time, approximately equal pressures are applied to the nozzles 201a to 208a, similarly to the case of Example 1. In addition, a fluid having flowed into a branching path from an inlet 221b spouts from 201b to 208b entirely in the same manner. Then, the spouted fluids collide with each other, and are mixed or cause a reaction in the collision part, because nozzles the 201a to 208a and nozzles 201b to 208b are arranged so that spouting directions intersect with each other.

The fluid-processing apparatus according to the present example as well has transportation paths with the same length, accordingly approximately equalize respective pressures applied to nozzles, makes mixing conditions or reaction conditions uniform, and can adequately mix the fluids or cause a reaction between them.

### Example 3

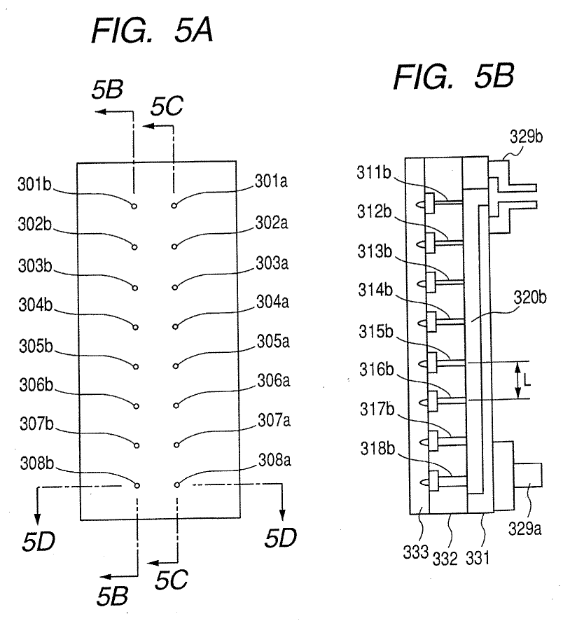

FIGS. 5A and 5B are explanatory drawings for describing a fluid-processing apparatus according to Example 3 of the present invention. FIG. 5A is a view illustrating the fluid-processing apparatus according to Example 3 when viewed from a lower side, and FIG. 5B is a cross-sectional view cut along a line 5B-5B in FIG. 5A. In addition, FIG. 5C is a cross-sectional view cut along a line 5C-5C, and FIG. 5D is a cross-sectional view cut along a line 5D-5D. An integrated micro-mixer according to the present example is produced by stacking a main flow path substrate 331, a compensation path substrate 332 and a nozzle substrate 333. Reference numerals 301a to 308b and 301b to 308b denote nozzles, and reference numerals 329a and 329b denote tube connectors.

A main flow path substrate 331 is formed by perpendicularly etching a silicon substrate from both sides. A compensation path substrate 332 has compensation paths 311a to 318a and 311b to 318b therein, which are formed by the step of perpendicularly etching the silicon substrate from both sides. The compensation paths 311a to 318a have cross sections with a circular shape, and are designed so as to decrease flow resistances in the paths as each distance from an inlet 329a increases, by increasing the diameter. Similarly, the compensation paths 311b to 318b are designed so as to decrease flow resistances in the paths as each distance from an inlet 329b increases, by increasing the diameter.

A nozzle substrate 333 is made of a glass plate, and has nozzles 301a to 308a and 301b to 308b formed therein by opening inclined holes with a laser beam, as illustrated in FIG. 5D. Because of being thus formed, each nozzle spouts a fluid not in a perpendicular direction to the substrate but at an arbitrary angle with respect to the substrate. In addition, the nozzles 301a to 308a and 301b to 308b are arranged so that respective spouting directions intersect with each other, and form mixing units respectively. Tube connectors 329a and 329b are produced by machining stainless steel, and are bonded to a branch path substrate 331 with an adhesive.

Assuming that a fluid is water, a viscosity coefficient μ is 1×10⁻³ Pa·s, and a density ρ is 1×10³ kg/m³. When a width (W) of a main flow path is set at 1 mm, a depth (T) is set at 500 μm, and each distance (L) between compensation paths 311a and 318a is set at 1 mm, (R) in Expressions 6 and 7 is determined by the following expression.

$$\begin{matrix}R = \frac{32 μ L}{{W}^{2} {T}^{2}} \\ = \frac{32 \times 1 \times {10}^{- 3} \times 1 \times {10}^{- 3}}{{( 1 \times {10}^{- 3} )}^{2} {( 500 \times {10}^{- 6} )}^{2}} \\ = 1.28 \times {10}^{8} [ P a / ( {m}^{3} / s ) ]\end{matrix}$$

When a length N between the compensation paths 311a and 318a is set at 500 μm, and a diameter d1 of the compensation path 311a is set at 200 μm, a flow resistance r1 in the compensation path 311a is determined into the following expression by using Expression 4.

$$\begin{matrix}{r}_{1} = \frac{128 μ N}{π {d}_{1}^{4}} \\ = \frac{128 \times 1 \times {10}^{- 3} \times 500 \times {10}^{- 6}}{{π ( 200 \times {10}^{- 6} )}^{4}} \\ = 1.27 \times {10}^{10} [ P a / ( {m}^{3} / s ) ]\end{matrix}$$

Accordingly, the following expression holds by using Expression 7.

$$\frac{P - p}{q} = {r}_{1} + R {\sum }_{k = 1}^{8} k = 1.73 \times {10}^{10} [ P a / ( {m}^{3} / s ) ]$$

From Expression 5 and Expression 7, flow resistances r2 to r8 in the compensation paths 312a to 318a, and diameters d2 to d8 can be determined by the following expression.

$${r}_{i} = \frac{P - p}{q} - R {\sum }_{k = i}^{n} k , {d}_{i} = \sqrt[4]{\frac{128 μ N}{π {r}_{i}}}$$

The following Table 1 is obtained by assigning the values into the Expressions and calculating them.

TABLE 1

| i | 1 | 2 | 3 | 4 |
|---|---|---|---|---|
| ri [Pa/(m³/s)] | 1.27E+10 | 1.37E+10 | 1.46E+10 | 1.54E+10 |
| di [μm] | 200.2 | 196.3 | 193.2 | 190.8 |
| i | 5 | 6 | 7 | 8 |
| ri [Pa/(m³/s)] | 1.60E+10 | 1.65E+10 | 1.69E+10 | 1.72E+10 |
| di [μm] | 188.8 | 187.4 | 186.3 | 185.6 |

Pressures applied to respective nozzles can be uniformized by setting the diameters of the compensation paths 311a to 318a at d1 to d8 in the above Table. Pressures applied to respective nozzles of compensation paths 311b to 318b also can be uniformized by setting the diameters similarly. Incidentally, the compensation paths were designed by using a simplified model in the present example, but it goes without saying that the compensation paths can be more accurately designed by using a more detailed model and fluid analysis software or the like.

In the next place, an operation of the fluid-processing apparatus according to the present example will be described. When a fluid supplied from a tube connector 329a by a pump, the fluid is introduced into a main flow path 320a formed in a main flow path substrate 331. Subsequently, the fluid passes through compensation paths 311a to 318a, and spouts out from nozzles 301a to 308a formed in a nozzle substrate 333. Here, approximately equal pressures are applied to the nozzles 301a to 308a. A fluid supplied from a tube connector 329b spouts from 301b to 308b entirely in the same manner. Then, the spouted fluids collide with each other, and are mixed or cause a reaction in the collision part, because the nozzles 301a to 308a and nozzles 301b to 308b are arranged so that spouting directions intersect with each other.

The fluid-processing apparatus according to the present example approximately equalizes respective pressures applied to nozzles by virtue of compensation paths 311a to 318a and 311b to 318b having different cross-sectional areas, accordingly makes reaction conditions uniform, and can adequately mix the fluids. This is because a cross-sectional area of a transportation path (compensation path) is designed so as to relatively increase as the transportation path (compensation path) is away from the inlet.

### Example 4

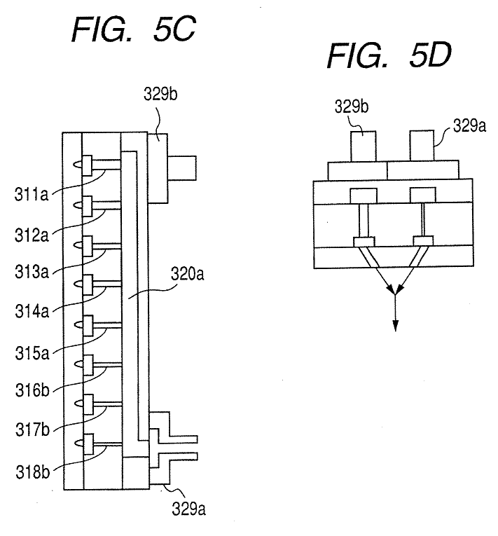

FIG. 6 is an explanatory view for describing a fluid-processing apparatus according to Example 4 of the present invention. The fluid-processing apparatus according to the present example is formed by stacking a branching path substrate on a nozzle substrate, and connecting a tube connector to them, as in the case of Example 2.

A branching path substrate 400 has 420a and 420b to 460a and 460b formed by the step of perpendicularly etching a silicon substrate from one side, and has inlets 410a and 410b formed by the step of perpendicularly etching the substrate from the other side until the etched hole penetrates the substrate.

Because 410a to 460a function in the same way as 410b to 460b, the functions of 410a to 460a will be now described. A fluid having flowed into a branching path 420a from the inlet 410a branches into two flow paths 421a and 422a at first, and then branches into two flow paths 431a and 432a at a branching path 430a.

Subsequently, the fluid flows into four flow paths 440a which longitudinally extend. To the four flow paths 440a, compensation paths 451a to 458a are connected. Furthermore, to the ends of the compensation paths 451a to 458a, nozzle connection ports 460a are connected. The nozzle connection ports 460a are arranged so as to connect with nozzles formed in a nozzle substrate when a branching path substrate 400 is joined to the nozzle substrate.

The compensation paths 451a to 458a are formed so that a flow resistance increases as the compensation path is nearer to the inlet 410a, and specifically are regulated so that all the pressures in the nozzle connection ports 460a can be approximately equal.

Assuming that a fluid is water, a viscosity coefficient μ is 1×10⁻³ Pa·s, and a density ρ is 1×10³ kg/m³. In the present example, a depth (T) is constant, because flow paths are formed by simultaneous etching.

Here, (T) is set at 500 μm. When a width (W) of a flow path 440a is set at 1 mm, and each distance (L) between compensation paths 451a and 458a is set at 1 mm, (R) in Expressions 6 and 7 is determined by the following expression.

$$R = \frac{32 μ L}{{W}^{2} {T}^{2}} = \frac{32 \times 1 \times {10}^{- 3} \times 1 \times {10}^{- 3}}{{( 1 \times {10}^{- 3} )}^{2} {( 500 \times {10}^{- 6} )}^{2}} = 1.28 \times {10}^{8} [ Pa / ( {m}^{3} / s ) ]$$

When a length N between the compensation paths are set at 500 μm, and a width w1 of the compensation path 451a is set at 200 μm, a flow resistance r1 in the compensation path 451a is determined into the following expression by using Expression 5.

$$\begin{matrix}{r}_{1} = \frac{32 μ N}{{w}_{1}^{2} {T}^{2}} = \frac{32 \times 1 \times {10}^{- 3} \times 500 \times {10}^{- 6}}{{( 200 \times {10}^{- 6} )}^{2} {( 500 \times {10}^{- 6} )}^{2}} \\ = 1.60 \times {10}^{9} [ Pa / ( {m}^{3} / s ) ]\end{matrix}$$

Accordingly, the following expression holds by using Expression 7.

$$\frac{P - p}{q} = {r}_{1} + R {\sum }_{k = 1}^{8} k = 6.21 \times {10}^{9} [ Pa / ( {m}^{3} / s ) ]$$

From Expression 5 and Expression 7, flow resistances r2 to r8 in the compensation paths 452a to 458a, and widths w2 to w8 can be determined by the following expression.

$${r}_{i} = \frac{P - p}{q} - R {\sum }_{k = 1}^{n} k , {w}_{i} = \frac{1}{T} \sqrt{\frac{32 μ N}{{r}_{i}}}$$

The following Table 2 is obtained by assigning the values into the Expressions and calculating them.

TABLE 2

| i | 1 | 2 | 3 | 4 |
|---|---|---|---|---|
| ri [Pa/(m³/s)] | 1.60E+09 | 2.62E+09 | 3.52E+09 | 4.29E+09 |
| wᵢ [μm] | 200.0 | 156.2 | 134.8 | 122.2 |
| i | 5 | 6 | 7 | 8 |
| ri [Pa/(m³/s)] | 4.93E+09 | 5.44E+09 | 5.82E+09 | 6.08E+09 |
| wᵢ [μm] | 114.0 | 108.5 | 104.8 | 102.6 |

Pressures applied to respective nozzles can be uniformized by setting widths of compensation paths 451a to 458a at w1 to w8 in the above Table. Pressures applied to respective nozzles of compensation paths 451b to 458b also can be uniformized by setting the widths similarly. Incidentally, the compensation paths were designed by using a simplified model in the present example, the compensation paths can be more accurately designed by using a more detailed model and fluid analysis software or the like.

The fluid-processing apparatus according to the present example has also compensation paths with different cross sectional areas, accordingly approximately equalizes respective pressures applied to nozzles, makes reaction conditions uniform, and can adequately mix the fluids. This is because a cross-sectional area of a transportation path (compensation path) is designed so as to relatively increase as the transportation path (compensation path) is away from the inlet.

### Example 5

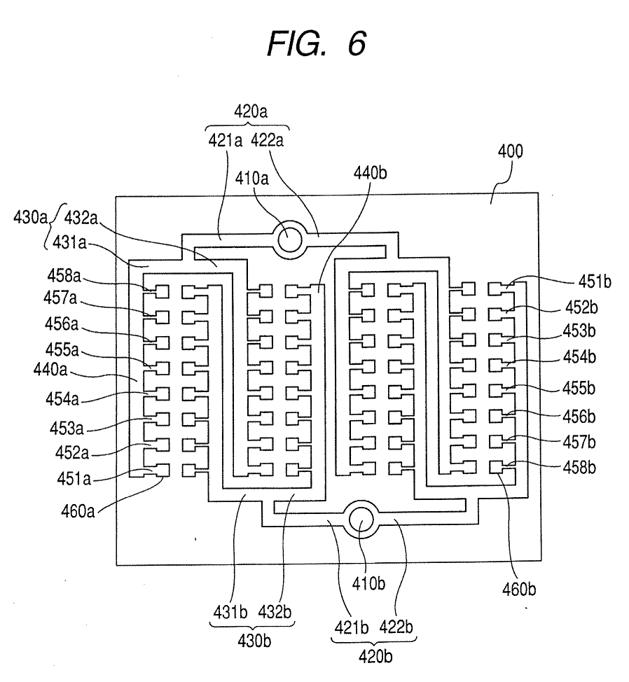

FIG. 7 is an explanatory view for describing a fluid-processing apparatus according to Example 5 of the present invention. The fluid-processing apparatus according to the present example is formed by stacking a branching path substrate on a nozzle substrate, and connecting a tube connector to them, as in the case of Example 2.

A branching path substrate 500 has 520a and 520b to 540a and 540b formed by the step of perpendicularly etching a silicon substrate from one side, and has inlets 510a and 510b formed by the step of perpendicularly etching the substrate from the other side until the etched hole penetrates the substrate.

Because 510a to 540a function in the same way as 510b to 540b, the functions of 510a to 540a will be now described. A fluid having flowed into the branching path 520a from the inlet 510a branches into three flow paths 521a and 523a at first.

A width of 522a is narrower than those of 521a and 523a so that the flow resistances of 521a to 523a can be equal.

In addition, three flow paths 521a to 523a further branch into three flow paths 531a to 533a respectively at a branching path 530a. The flow path 532a is formed serpentine so as to acquire the same path length as those of 531a and 533a, in order to make flow resistances of 531a to 533a equal.

Furthermore, to the ends of the paths 531a to 533a, nozzle connection ports 540a are connected. The nozzle connection ports 540a are arranged so as to connect with nozzles formed in a nozzle substrate when the branching path substrate 500 is joined to the nozzle substrate.

The fluid-processing apparatus according to the present example approximately equalizes respective pressures applied to nozzles, makes reaction conditions uniform, and can adequately mix the fluids.

### Example 6

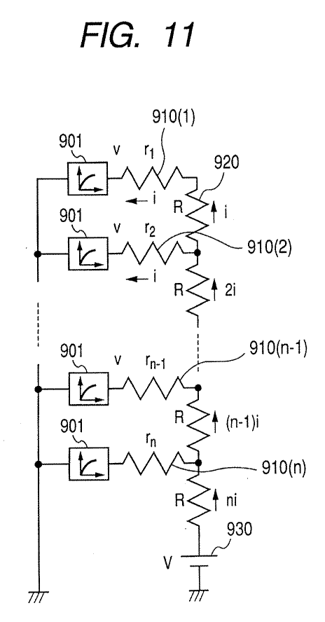

FIG. 12 is a conception diagram illustrating a fluid-processing system according to Example 6 of the present invention.

Reference numeral 1001 denotes a fluid-processing system according to the present invention. Reference numeral 1002 denotes a high-pressure gas for transporting a liquid, and reference numeral 1003 denotes a regulator (fluid controlling unit) for controlling a transportation pressure. Reference numerals 1004 and 1005 denote a first reaction liquid tank 1004 (feed material storage unit) and a second reaction liquid tank 1005 (feed material storage unit) both for storing a reaction liquid (feed material). Reference numeral 1006 denotes a flow meter for monitoring a flow rate of the reaction liquid, and reference numeral 1010 denotes a recovery tank (outflow-storing unit) for recovering (storing) a reaction product. A reaction vessel 1008 incorporates a fluid-processing apparatus 1007 according to the present invention therein.

An actual example of mass-producing a dispersion of a magenta pigment by using a fluid-processing system according to the present example will be now described.

A pigment solution is stored in the first reaction liquid tank 1004, and an ion-exchanged water is stored in the second reaction liquid tank 1005 at room temperature.

A method for preparing the pigment solution to be used in the example will be now described. The first reaction liquid is prepared by the steps of: adding 100 parts of dimethyl sulfoxide to 10 parts of quinacridone pigment of C. I. Pigment Red 122 to suspend the pigment, subsequently adding 40 parts of polyoxyethylene lauryl ether to the suspension as a dispersant, and adding 25% of an aqueous potassium hydroxide solution to the dispersion until those compounds are dissolved.

Each reaction liquid is transported to a reaction vessel 1008 by a pressure of a high-pressure gas 1002. At this time, flow rates of the reaction liquids are regulated by adjusting a regulator 1003 while monitoring a flow meter 1006. Thereby, the pigment solution spouts out at a flow velocity of 23.3 m/s and water spouts out at a flow velocity of 50 m/s, and both liquids intersect and mix with each other in the reaction vessel 1008 placed in a lower part of a fluid-processing apparatus 1007. As a result of the mixture, a dispersion 1009 of magenta pigment is produced, and is collected in a recovery tank 1010.

Conventionally, a new design has been necessary for a plant for producing a large amount of a mixed substance with a facility of a large scale, even though a small amount of the mixed substance has been produced by an experimental production facility, and has expended enormous efforts and time for obtaining the reproducibility of a reaction.

A fluid-processing system according to the present invention can cope with a necessary amount of production by integrating the fluid-mixing apparatus, and accordingly can greatly reduce the above described efforts and time. Furthermore, the fluid-processing system according to the present invention can compose the fluid-processing system coping with a necessary amount of production, by arranging an arbitrary number of fluid-processing apparatuses.

A fluid-processing apparatus according to the present invention can uniformly mix or react fluids with each other by discharging the fluids from many nozzles at a uniform discharging pressure to collide them, and accordingly can be utilized for a fluid-processing system in the chemical industry, the biochemical industry, the food-stuff industry and the drug industry.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-278110, filed Oct. 11, 2006, which is hereby incorporated by reference herein in its entirety.

What is claimed is:

1. A fluid-processing apparatus comprising first and second units each of which units is comprised of one inlet in which a fluid flows, a set of transportation paths divaricated in turn from the inlet as an origin and outlets at the ends of the transportation path, and bring a first fluid flowing from the outlet of the first unit into contact with a second fluid flowing from the outlet of the second unit to mix the fluids or bring the fluids react with each other,
the transportation paths from the inlet to the outlets varying in length in a range of 20% or less.

2. The fluid-processing apparatus according to claim 1, wherein the set of transportation paths is firstly bifurcated from the inlet to form two first branching paths, and further bifurcated from each of the first branching paths to form two second branching paths.

3. The fluid-processing apparatus according to claim 2, wherein the first branching paths and the second branching paths are formed in their respective substrates different from each other.

4. The fluid-processing apparatus according to claim 3, wherein the different substrates are stacked on each other to connect the first branching paths with the second branching paths.

5. The fluid-processing apparatus according to claim 1, wherein the number of the outlets and the ends of the set of transportation paths is an integral multiple of 2.

6. The fluid-processing apparatus according to claim 1, wherein the inlet is prepared on a center line of the set of transportation paths.

7. A fluid-processing system comprising the fluid-processing apparatus according to claim 1, a transportation unit for transporting a fluid, a fluid control unit for controlling the transportation unit, a feed material-storing unit for storing the fluid to be supplied to the fluid-processing apparatus, and an outflow-storing unit for storing the fluid which has flowed out from the fluid-processing apparatus.

8. A fluid-processing apparatus comprising first and second units each of which units is comprised of one inlet in which a fluid flows, a set of transportation paths divaricated in turn from the inlet as an origin and outlets at the ends of the transportation path, and bring a first fluid flowing from the outlet of the first unit into contact with a second fluid flowing from the outlet of the second unit to mix the fluids or bring the fluids react with each other,
the set of transportation paths comprising branching paths with greater cross sectional areas as away from the inlet.

9. The fluid-processing apparatus according to claim 8, wherein the set of transportation paths comprises a main flow path which connects to the inlet and compensation paths branching from the main flow path,
the compensation paths being different from each other in cross sectional area.

10. The fluid-processing apparatus according to claim 9, wherein the compensation paths are equal in length.

11. A fluid-processing system comprising the fluid-processing apparatus according to claim 8, a transportation unit for transporting a fluid, a fluid control unit for controlling the transportation unit, a feed material-storing unit for storing the fluid to be supplied to the fluid-processing apparatus, and an outflow-storing unit for storing the fluid which has flowed out from the fluid-processing apparatus.
